(19) United States
(12) Patent Application Publication
(10) Pub. No.: US 2026/0341748 A1
(43) Pub. Date: Oct. 29, 2026

(54) SEPARATOR PLATE FOR AN ELECTROCHEMICAL CELL AND FUEL CELL

(71) Applicant: SYMBIO FRANCE, Saint-Fons (FR)

(72) Inventor: Hadrien Dufour, Vénissieux (FR)

(21) Appl. No.: 19/115,214

(22) PCT Filed: Sep. 25, 2023
(86) PCT No.: PCT/EP2023/076385

§ 371 Date: Mar. 25, 2025

(30) Foreign Application Priority Data
Sep. 26, 2022 (FR) FR2209742

(51) Int. Cl. H01M 8/0263; H01M 8/026; H01M 8/1004

(52) U.S. Cl. CPC H01M 8/0263; H01M 8/026; H01M 8/1004

(57) ABSTRACT

The invention relates to a separator plate which includes, in a first face: a plurality of corrugated channels for the circulation of a first reactive gas. The corrugated channels having respective end portions all extending in the same first direction and forming corrugations having the same specific period. A plurality of oblique channels, each extending in a second direction intersecting the first direction. The end portion of each corrugated channel connecting to one of the oblique channels at a junction point. The junction points defining projection points projecting onto a straight line parallel to the first direction. The projection being in a third direction perpendicular to the first direction. The projection points being regularly spaced apart from one another in the first direction and separated from one another by a constant spacing equal to a multiple of the specific period.

### FIELD

The present invention relates to a fuel cell.

### BACKGROUND

Such a fuel cell includes a stack of electrochemical cells, each of which typically comprises:
An electrolytic membrane having first and second large faces opposite each other;
First and second catalytic layers, arranged against the first and second large faces of the electrolytic membrane;
Two separator plates, the first and second catalytic layers being arranged between one of the separator plates and the electrolytic membrane, respectively.

Channels for the circulation of reactive gases are provided on the separator plates. In particular, each separator plate may include corrugated channels extending along the same first direction, connecting to rectilinear oblique channels.

The oblique channels may connect to portions of the corrugated channels that have different orientations from each other relative to the first direction.

In such case, the head loss for the reactive gas circulating in the channels is not the same, depending on the orientation at the junction point.

As a result, the reactive gas flow-rate is not the same in all channels, and the fuel cell operation is not optimal.

The gas is indeed poorly distributed in contact with the catalytic layer adjacent to the separator plate.

It is also possible to provide that the end parts of the corrugated channels connecting to the oblique channels are rectilinear and parallel to each other.

However, in such case there is a risk that the end parts of the corrugated channels of the different plates will interlock with each other at the time of assembly of the stack, when the plates are pressed against each other.

In such context, the invention aims to propose a separator plate for an electrochemical cell of a fuel cell contributing to solving the above problems.

### SUMMARY

To this end, the invention relates to a separator plate for an electrochemical cell of a fuel cell, the separator plate including, in a first face:
a plurality of corrugated channels for the circulation of a first reactive gas, the corrugated channels having respective end parts all extending along a same first direction and forming corrugations having a same specific period;
a plurality of oblique channels, each extending along a second direction intersecting the first direction, the end part of each corrugated channel connecting to one of the oblique channels at a junction point;
the junction points defining projection points projecting onto a straight line parallel to the first direction, the projection being in a third direction perpendicular to the first direction, said projection points being regularly spaced apart from one another along the first direction and separated from one another by a constant gap equal to a multiple of the specific period.

Because the projection points are regularly spaced apart from each other along the first direction, and are separated from each other by a constant distance equal to a multiple of said specific period, the end of the corrugated channel at the junction point always has the same orientation for all the corrugated channels.

As a result, the connection between the oblique channels and the corrugated channels is substantially identical for all the corrugated channels.

The head loss for the reactive gas circulating in the channels is practically the same, so that the distribution of the reactive gas in the different corrugated channels is uniform.

As a result, the first catalyst layer is supplied with the reactive gas homogeneously, and the operation of the fuel cell is improved.

Moreover, the end parts of the corrugated channels have corrugations, which contributes to prevent the channels of the different plates from interlocking into each other at the time of assembly of the fuel cell.

The separator plate may further have one or a plurality of the following features, considered individually or in all technically possible combinations:
the projection points are separated from each other by a constant gap equal to the said specific period;
each corrugated channel comprises a main part extending along the first direction and forming large corrugations having a predetermined elongate period greater than the specific period of the corrugations of the end part, the end part of a corrugated channel extending between the main part and the junction point of said corrugated channel;
the number of oblique channels is less than the number of corrugated channels, a plurality of corrugated channels opening into the same oblique channel;
the junction points of corrugated channels opening into the same oblique channel define the same projection point on the straight line;
the junction points of corrugated channels opening into the same oblique channel define at least two distinct projection points on the straight line;
the junction points are placed on a straight line intersecting the first direction;
the end parts of the corrugated channels have, at the junction points thereof, respective tangents all parallel to each other;
the oblique channels have oblique end parts connected to the junction points, the oblique end parts being rectilinear and parallel to each other;
the oblique end parts extend along the third direction, perpendicular to the first direction.

According to a second aspect, the invention relates to a fuel cell comprising a plurality of electrochemical cells, each electrochemical cell comprising:
an electrolytic membrane, having first and second large faces opposite each other;
first and second catalytic layers, arranged against the first and second large faces of the electrolytic membrane;
a separator plate having the features, the first catalytic layer being arranged between a first face of the separator plate and the electrolyte membrane.

### BRIEF DESCRIPTION OF THE DRAWINGS

Other features and advantages of the invention will be clear from the description thereof which is given below as an example, but in no way limited to, with reference to the enclosed Figures, among which:

FIG. 1 is an exploded simplified schematic representation of a cell of a fuel cell according to the invention;

FIG. 2 is a schematic partial perspective view of the cell of the fuel cell shown in FIG. 1;

FIG. 3 is a schematic representation, in top view, of the channels of the first separator plate shown in FIGS. 1 and 2; and

FIG. 4 is an enlarged top view of a zone IV of the first separator plate shown in FIG. 1, for a variant embodiment; and

FIG. 5 is a schematic representation similar to the same shown in FIG. 3 for another variant of embodiment.

### DETAILED DESCRIPTION

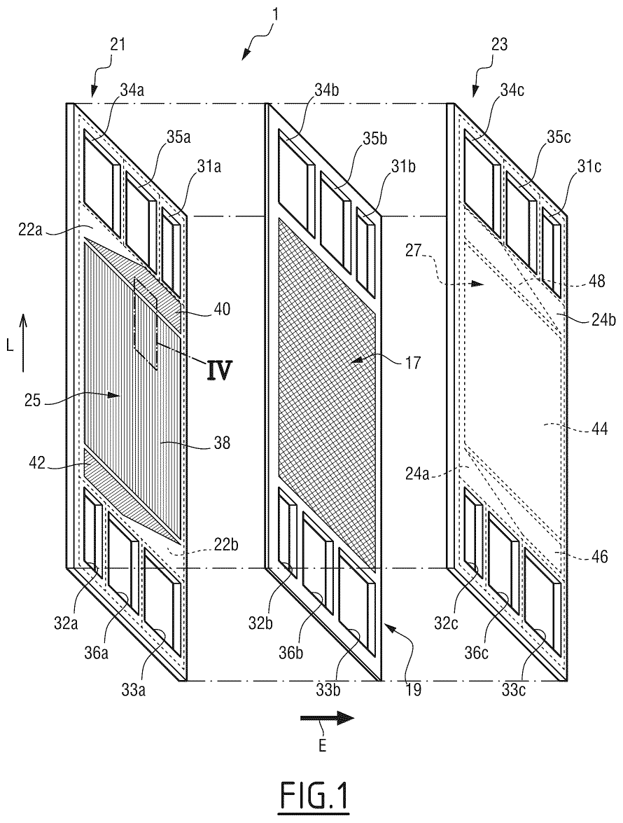

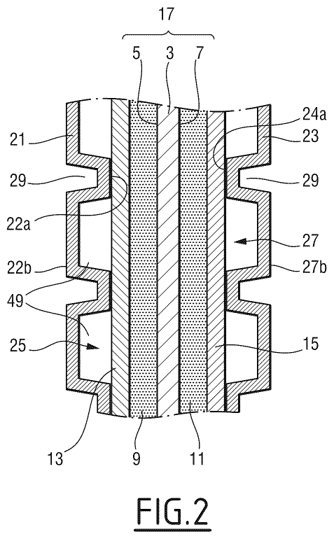

The fuel cell 1 includes a stack of electrochemical cells, each of which comprises, as illustrated in FIGS. 1 and 2, an electrolytic membrane 3, having first and second large faces 5 and 7.

The electrochemical cell of the fuel cell further comprises first and second catalytic layers 9 and 11 arranged against the first and second large faces 5 and 7 of the electrolytic membrane 3, e.g. by being formed on the first and second large faces 5 and 7 of the electrolytic membrane 3, or at least one or both of the catalytic layers being formed on a gas diffusion layer which is arranged against the corresponding large face 5 or 7 of the electrolytic membrane 3.

The membrane is e.g. a proton exchange polymer membrane.

Typically, a gas diffusion layer 13 is arranged against the first catalytic layer 9, opposite the electrolytic membrane 3. In the same way, another gas diffusion layer 15 is arranged against the second catalytic layer 11, opposite the membrane 3.

As an example, the first catalytic layer 9, if appropriate together with the layer 13, forms an anode. The second catalytic layer 11, if appropriate together with the layer 15, forms a cathode.

The electrolytic membrane 3, the first and second catalytic layers 9 and 11 and the gas diffusion layers 13 and 15 together belong to a membrane-electrode assembly (MEA) 17.

The membrane-electrode assembly 17 of the fuel cell 1 typically further includes a frame 19, internally delimiting a window wherein the electrolytic membrane 3 is fastened. The frame 19 is e.g. mainly formed of one or two layers of a polymer film, e.g. polyethylene naphthalate or terephthalate (PEN or PET), with a total thickness which may be less than 200 micrometers or even less than 100 micrometers.

Each electrochemical cell of the fuel cell 1 further includes a first separator plate 21 having a first face 22a and a second face 22b opposite the first face 22a. The first catalytic layer 9 is arranged between the first face 22a and the electrolytic membrane 3.

In the example shown, the gas diffusion layer 13 and the first catalytic layer 9 are interposed between the first face 22a of the first separator plate 21 and the electrolytic membrane 3.

Symmetrically, each electrochemical cell of the fuel cell 1 includes a second separator plate 23 having a first face 24a and a second face 24b opposite the first face 24a. The second catalytic layer 11 is arranged between the first face 24a and the electrolytic membrane 3.

More precisely, the gas diffusion layer 15 and the second catalytic layer 11 are interposed between the first face 24a of the second separator plate 23 and the electrolytic membrane 3.

The first separator plate 21 carries a set 25 of channels for the circulation of a first reactive gas.

The set of channels 25 is formed on the first face 22a of the first separator plate 21 which is oriented toward the first catalytic layer 9 of the electrochemical cell considered, hence oriented toward the electrolytic membrane 3 of the electrochemical cell considered.

The first reactive gas is typically hydrogen.

A set 27 of channels is formed on the first face 24a of the second separator plate 23 which is oriented toward the second catalytic layer 11 of the electrochemical cell considered, hence oriented toward the electrolytic membrane 3 of the electrochemical cell considered. The channels 27 are provided for the circulation of a second reactive gas.

The second reactive gas is typically air, or oxygen gas, or any other suitable gas.

The separator plate 21, the MEA 17 and the second separator plate 23 are stacked along a stacking direction E, one on top of the other.

The stacking direction E is shown in FIG. 1.

Together, same define a cell of the fuel cell 1. Seals (not shown) are generally provided between each separator plate and the MEA. The fuel cell 1 includes a large number of cells, stacked on top of each other along the stacking direction E.

Only one cell is represented in FIGS. 1 and 2.

The first separator plate 21 of one of the cells is thus superposed and in electrical contact with the second separator plate 23 of the neighboring cell in the stack.

In certain fuel cell architectures, channels 29 for the circulation of a heat-transfer fluid are formed between said first separator plate 21 of a cell and said second separator plate 23 of the neighboring cell, hence between two neighboring cells. The second faces 22b/24b of the two plates can be welded together or bonded to each other, or simply clamped against each other in the stack of cells, with, in particular in the latter case, the possibility of providing a sealing system between the two plates. The heat-transfer fluid is used to cool the cells of the fuel cell during the operation thereof.

In FIG. 1, the circulation channels 29 for the heat-transfer fluid are not shown on the second separator plate 23.

In the example shown, the first and second separator plates 21, 23 and the frame 19 are rectangular and have respective shapes and sizes substantially identical to each other.

The first and second separator plates 21, 23 and the frame 19 have a generally elongate shape along a longitudinal direction L, shown in FIG. 1.

Orifices 31a, 31b and 31c are provided in the first separator plate 21, in the frame 19 and in the second separator plate 23, respectively. The orifices 31a, 31b and 31c are placed coincident with each other and form a distribution manifold for the first reactive gas.

The orifices 31a, 31b and 31c are preferentially placed at a corner of the first separator plate 21, of the frame 19 and of the second separator plate 23, respectively.

The first separator plate 21, the frame 19 and the second separator plate 23 further include orifices 32a, 32b and 32c placed coincident with each other. The orifices 32a, 32b and 32c define a collector for discharging the first reactive gas. Same are preferentially placed in the corners opposite the orifices 31a, 31b and 31c.

The first separator plate 21, the frame 19 and the second separator plate 23 further include orifices 33a, 33b and 33c respectively, placed coincident with each other. Same define a manifold for distributing the second reactive gas. Same are preferentially situated at another corner of the first separator plate 21, of the frame 19 and of the second separator plate 23, respectively.

The first separator plate 21, the frame 19 and the second separator plate 23 also have orifices 34a, 34b and 34c respectively, placed coincident with each other. Same are preferably situated at corners opposite the orifices 33a, 33b and 33c. Same define an exhaust manifold for the second reactive gas.

The first separator plate 21, the frame 19 and the second separator plate 23 also have orifices 35a, 35b and 35c respectively, placed coincident with each other. The orifices 35a, 35b and 35c together define a heat-transfer fluid supply manifold. Same are situated e.g. between the orifices 34a and 31a, between the orifices 34b and 31b, and between the orifices 34c and 31c, respectively.

Finally, the first separator plate 21, the frame 19 and the second separator plate 23 define orifices 36a, 36b and 36c respectively, placed coincident with each other. Together, same define a heat transfer fluid discharge manifold. Same are placed e.g. between the orifices 32a and 33a, between the orifices 32b and 33b, and between the orifices 32c and 33c, respectively.

As an example, the orifices 34a, 35a and 31a are placed at a longitudinal end of the first separator plate 21 and are juxtaposed along a transverse direction over the width of the plate. Still as an example, the orifices 32a, 36a and 33a are placed at the other longitudinal end of the first separator plate 21 and are juxtaposed transversely over the width of the plate.

The orifices 34b, 35b and 31b are placed at a longitudinal end of the frame 19 and are juxtaposed in a transverse direction over the width of the frame. The orifices 32b, 36b and 33b are placed at the other longitudinal end of the frame 19 and are juxtaposed transversely over the width of the frame.

The orifices 34c, 35c and 31c are placed at a longitudinal end of the second separator plate 23 and are juxtaposed in a transverse direction over the width of the plate. The orifices 32c, 36c and 33c are placed at the other longitudinal end of the second separator plate 23 and are juxtaposed transversely over the width of the plate.

The set of channels 25 formed on the first separator plate 21 ensures the circulation of the first reactive gas, on the first face 22a of the first separator plate oriented toward the electrolytic membrane 3, from the orifice 31a to the orifice 32a.

In the same way, the set of channels 27 formed on the second separator plate 23 ensure the circulation of the second reactive gas, over the first face 24a of the second separator plate oriented toward the electrolytic membrane 3, from the orifice 33c to the orifice 34c.

The direction of circulation described hereinabove in the set of channels 25 and/or in the set of channels 27 is an example and could be reversed, for one or other of the sets, or for both.

As can be seen in FIG. 1, the first separator plate 21 has a central zone 38 in which the channels of the assembly 25 extend along a general direction parallel to the longitudinal direction L.

The first separator plate 21 further includes a distribution zone 40 interposed, along the longitudinal direction L, between the central zone 38 and the end of the first distribution plate 21 in which the orifices 31a, 35a and 34a are formed.

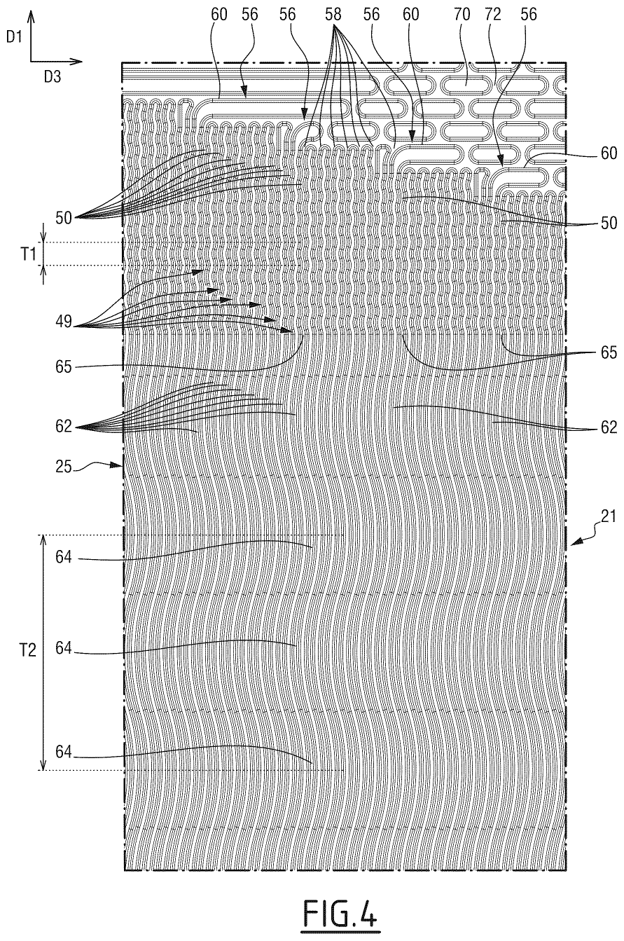

Among the channels of the set of channels 25, same formed in the distribution zone 40 include oblique channels 56 which extend along a general direction obliquely with respect to the longitudinal direction L and fluidically connect the channels of the central zone 38 to the orifice 31a. At least one section of the oblique channels 56 may be perpendicular to the longitudinal direction L, as will be seen with reference to FIG. 4.

The first separator plate 21 further includes a second distribution zone 42. The second distribution zone 42 is interposed, along the longitudinal direction L, between the central zone 38 and the other longitudinal end of the first separator plate 21, wherein the orifices 32a, 36a and 33a are formed

Among the channels of the set of channels 25, same formed in the second distribution zone 42 include oblique channels 56 which extend in a general direction obliquely with respect to the longitudinal direction L and fluidically connect the channels of the central zone 38 to the orifice 32a. At least one section of these oblique channels 56 may be perpendicular to the longitudinal direction L.

The second separator plate 23 is formed as the first separator plate.

Same also has a central zone 44 wherein the channels of the assembly 27 extend along a general direction parallel to the longitudinal direction L. Same comprises a distribution zone 46 wherein the channels of the assembly 27 extend along a general direction obliquely with respect to the longitudinal direction L. The channels enable the channels of the central zone 44 to be fluidically connected to the orifice 33c. Same also include a second distribution zone 48, wherein the channels of the assembly 27 extend along a general direction obliquely with respect to the longitudinal direction L. The channels serve to connect the channels of the central zone 44 fluidically to the orifice 34c.

The distribution zone 46 is interposed along the longitudinal direction between the central zone 44 and the end of the second separator plate 23 in which the orifices 32c, 36c and 33c are formed. The other distribution zone 48 is interposed along the longitudinal direction L between the central zone 44 and the end of the second separator plate 23 wherein the orifices 31c, 35c and 34c are formed.

The zones 44, 46 and 48 are delimited as broken lines in FIG. 1, because the channels 27 for the circulation of the second reactive gas are formed on the first face 24a of the separator plate 23, not visible in FIG. 1.

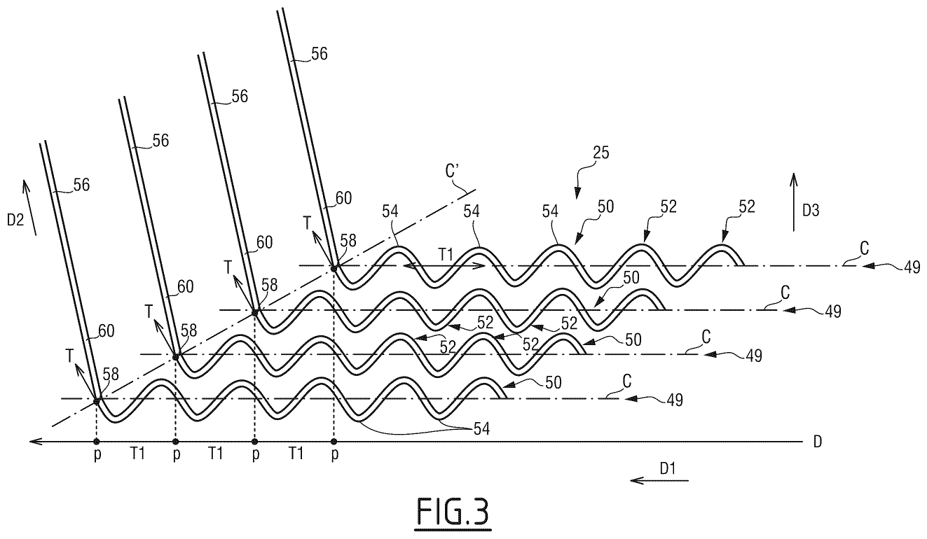

According to the invention, and as shown in FIG. 3, the first separator plate 21 includes a plurality of corrugated channels 49 for the circulation of the first reactive gas. The corrugated channels 49 have end parts 50 all extending along the same first direction D1 and forming corrugations having the same first specific period T1.

The corrugated channels 49 form part of the set 25 of channels ensuring the circulation of the first reactive gas.

Each end part 50 extends along the first direction D1 in the sense that same extends along a general direction parallel to the first direction D1.

The corrugations of the end part 50 form bumps 52 alternately on both sides of a central line C, parallel to the first direction D1. All the bumps 52 taken perpendicularly to the center line C have the same transverse offset from the center line C in the plane of FIG. 3, which is the plane of extension of the first plate.

The transverse offset corresponds to the distance, perpendicular to the first direction D1, between the central line C and the top of the bump 52.

The period T1 corresponds to the spacing between the tops 54 of two consecutive bumps situated on the same side of the central line C, the spacing being taken along the first direction D1, along the central line C.

The corrugations of the end parts 50 are in phase in the first direction D1.

Thereof means that the bumps 52 of the different end parts 50 are situated, along the first direction D1, at the same positions. In other words, all the bumps 52 situated on a first side of the central line C for a given end part 50 are situated, along the direction D1, in the same positions as the bumps of the other end parts 50 situated on the same side.

In the example shown, the bumps 52 of all the end parts 50 have the same transverse offset.

The spacing between the respective central lines C of the end parts 50 of the different corrugated channels is substantially constant. The spacing is taken perpendicularly to the first direction D1.

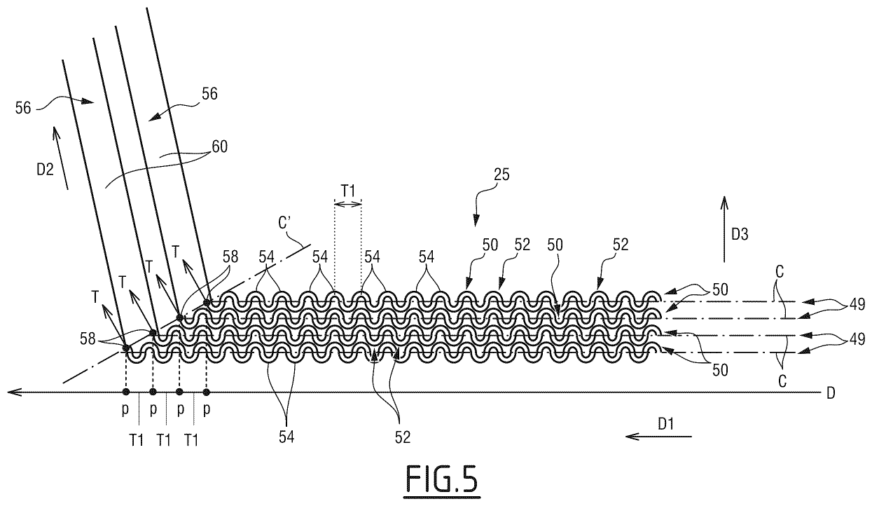

In FIGS. 3 and 5, to make the drawing clear, the spacing between the corrugated channels 49 is greatly exaggerated compared with the width of the corrugated channels 49.

The first separator plate 21 further includes a plurality of oblique channels 56, each extending along a second direction D2 intersecting the first direction D1.

The oblique channels 56 are part of the set 25 of channels ensuring the circulation of the first reactive gas.

In the example shown, the oblique channels 56 are parallel to each other, and hence all extend along the same second direction D2 intersecting the first direction D1.

In a variant, the oblique channels 56 extend along respective second directions slightly different from one another, and form an angle of at most 30° with one another, preferably at most 15° with one another.

The spacing between the oblique channels 56 is substantially constant. The spacing is taken perpendicularly to the second direction D2.

The corrugated channels 49 are typically formed on the central zone 38. The first direction D1 then corresponds to the longitudinal direction L. The oblique channels 56 are typically formed in the distribution zone 40 or 42.

As illustrated in FIG. 3, the end part 50 of each corrugated channel 49 is connected to one of the oblique channels 56 at a junction point 58.

The end part 50 is connected directly to the corresponding oblique channel 56. Thereof means that the oblique channel 56 directly continues the end part 50, the first reactive gas flowing between the oblique channel 56 and the end part 50 of the corrugated channel.

The oblique channels 56 have oblique end parts 60 connected to the junction points 58.

The oblique end parts 60 are preferably rectilinear and parallel to each other. These oblique end parts 60 extend along the second direction D2.

The second direction D2 forms with the first direction D1 an angle typically comprised between 30° and 90°. For example, the second direction D2 is perpendicular to the first direction D1.

The junction points 58 define projection points p in projection onto a straight line D parallel to the first direction D1 (FIG. 3). The projection is taken along a third direction D3 perpendicular to the first direction D1.

Said projection points p are regularly spaced from one another along the first direction D1 and separated from one another by a constant gap equal to a multiple of said specific period T1.

A gap equal to a multiple of the specific period T1 means herein that the gap is equal to the specific period T1 multiplied by an integer greater than or equal to one.

In other words, the junction points 58 are regularly spaced from one another along the first direction D1. Same are separated from one another by a constant gap equal to a multiple of the specific period T1.

In the example shown, the gap between the projection points p is equal to the period T1.

In a variant, the gap is twice T1, or three times T1, or any other multiple.

As a result, and as illustrated in FIG. 3, the end parts 50 of the corrugated channels have respective tangents T at the junction points 58 thereof, all parallel to each other.

The tangents to the end parts 50 of the corrugated channels, taken at the junction points 58, are considered herein.

As a result, the inclination between the end of the oblique channel 56, taken at the junction point 58, and the end of the part 50, also taken at the junction point 58, is substantially the same whatever the corrugated channel 25 considered.

The inclination is strictly the same if the oblique end parts 60 of all the oblique channels 56 are oriented along the same second direction.

The inclination may be slightly different from one channel to another, if the oblique end parts 60 do not all extend in the same second direction.

However, because the oblique end parts 60 extend along directions close to one another, the inclinations at the different junction points 58 are close to one another, so that the head losses for the first reactive gas flowing in the different channels are not significantly different.

FIG. 4 shows in more detail an example of a first separator plate 21. Same shows only one zone of the separator plate. The view in FIG. 4 is a zoom of the zone IV shown in FIG. 1.

It can be seen in FIG. 4 that each corrugated channel 49 comprises a main part 62 extending along the first direction D1 and forming large corrugations.

Typically, the main part 62 extends over the greater part of the length of the central zone 38. The first direction D1 corresponds herein to the longitudinal direction L.

The end part 50 continues the main part 62 of a given corrugated channel 49.

The large corrugations have a determined elongate period T2, greater than the specific period T1 of the corrugations of the end part 50.

The main part 62 extends along the same central line C as the end part 50. The large corrugations form bumps 64 on either side of the central line C. The elongate period T2 corresponds to the spacing, taken along the first direction D1, between the tops of two successive bumps 64 situated on the same side of the central line C.

Typically, the elongate period T2 is comprised between 1.5 times and 20 times the period T1, else preferably between 5 and 15 times the period T1.

The bumps 64 have, perpendicular to the central line C, a transverse off-set greater than same of the bumps 52.

The large corrugations of the main parts 62 of the different channels are in phase, i.e. the bumps 64 of the different channels are located at the same level along the first direction D1.

The end part 50 and the main part 62 of the same corrugated channel 49 meet at an end point 65.

The limit point 65 corresponds to the limit between the small corrugations and the large corrugations. The limit points 65 of the different corrugated channels are aligned along the third direction D3, perpendicular to the first direction D1.

In the example of embodiment of FIG. 3, the number of oblique channels 56 is equal to the number of corrugated channels 49. The corrugated channels 49 each come out into a different oblique channel 56.

In the example shown in FIG. 3, the junction points 58 are placed on a line. The straight line C′ is shown with a dash-dot line in FIG. 3. Same intersects the first direction D1.

Same also intersects the second direction or directions D2.

The corrugated channels 49 each include, as indicated hereinabove, a main part with large corrugations, in addition to the end part 50. The main part is not shown in FIG. 3.

Because the end points 65 of the different corrugated channels 49 are aligned along the direction D3, the end parts 50 of the corrugated channels 25 are all of different lengths, the lengths being taken along the first direction D1.

More precisely, the end parts 50 of the corrugated channels 49 are juxtaposed along the third direction D3, perpendicular to the first direction D1. The end part 50 situated on a first edge of this juxtaposition, the upper edge in the representation of FIG. 3, is the shortest. The length of the end part 50 increases from the first edge to the second edge. In the example shown in FIG. 3, the length increases by T1 when moving from one corrugated channel 49 to another.

In other words, in the example shown in FIG. 3, the end parts 50 of two adjacent corrugated channels 49 have a difference in length of T1.

In the embodiment shown in FIG. 4, the number of oblique channels 56 is less than the number of corrugated channels 49, a plurality of corrugated channels 49 coming out into the same oblique channel 56.

In the example of FIG. 4, the junction points 58 of the corrugated channels 49 coming out into the same oblique channel 56 define the same projection point p on the straight line D.

Thereby, in the example shown in FIG. 4, the end parts 50 of the corrugated channels 49 coming out into the same oblique channel 56 have the same length along the first direction D1.

The corrugated channels 49 coming out into the same oblique channel 56 are juxtaposed next to one another along the third direction D3.

In the example shown in FIG. 4, the first separator plate 21 includes seven neighboring corrugated channels 49 coming out into each oblique channel 56.

In other examples of embodiments, the number of oblique channels 56 is less than the number of corrugated channels 49, a plurality of corrugated channels 49 coming out into the same oblique channel 56, but the junction points 58 of the corrugated channels 49 coming out into the same oblique channel 56 define at least two different projection points p on the straight line D.

In such a case, same all define different projection points p on the straight line D. In a variant, the junction points 58 of certain corrugated channels 49 define different projection points p on the straight line D, and the junction points 58 of other corrugated channels 49 define the same projection point p on the straight line D.

In such cases, the end parts 50 of the corrugated channels 49 the projection points p of which are different have different lengths along the first direction D1.

The corrugated channels 49 coming out into the same oblique channel 56 are juxtaposed next to one another in the third direction D3, and the projection points p are consecutive on the straight line D.

For example, two neighboring corrugated channels 49 come out into each oblique channel.

As illustrated in FIG. 4, the walls 70 separating the oblique channels 56 have interruptions 72 through which the oblique channels 56 communicate with each other. It is thereby possible to balance the pressures between the oblique channels 56.

The second separator plate 23 also supports a network of channels. Same may also include a plurality of corrugated channels for the circulation of the second reactive gas, and a plurality of oblique channels.

The corrugated channels of the second separator plate may in such case be similar to the corrugated channels of the first separator plate. Same will thus not be described herein in detail.

The oblique channels of the second separator plate may be similar to the oblique channels of the first separator plate. Same will thus not be described herein in detail.

The junction points between the oblique channels and the corrugated channels may also define projection points on a straight line D parallel to the first direction, the projection being along the third direction, the projection points being regularly spaced from one another along the first direction and separated from one another by a constant gap equal to a multiple of the period of the corrugations formed in the end parts of the corrugated channels.

The period is e.g. the same as the period of the corrugations of the end parts of the channels of the first separator plate. In a variant, the period is different.

Similarly, the extended period of the large corrugations of the corrugated channels of the second separator plate is, e.g. equal to the extended period of the corrugated channels of the first separator plate. In a variant, same is not equal to the extended period of the corrugated channels of the first separator plate

The fuel cell described hereinabove has multiple advantages.

When the projection points are separated from one another by a constant gap, equal to the specific period of the corrugations, the projection points are as close as possible along the first direction. It is thereby possible to draw a very tight network of oblique channels.

When each corrugated channel comprises a main part extending along the first direction and forming large corrugations each having a specific elongate period longer than the specific period of corrugations of the end part, the risks of deformation of the channels of the first separator plate are reduced. The corrugated channels have more pronounced variations in shape at the large corrugations, the main part of the corrugated channel thus providing a better mechanical resistance when the separating plates are clamped against each other.

Providing a smaller number of oblique channels than the number of corrugated channels, a plurality of corrugated channels coming out into the same oblique channel, facilitates the manufacture of the first separator plate and limits the head losses in the oblique channels. It is thereby possible to form a large number of corrugated channels, and thus to guarantee a very homogeneous distribution of the first reactive gas in the central part of the plate

Providing that the junction points of the corrugated channels coming out into the same oblique channel define the same projection point on the straight line serves to impart the oblique channels with an orientation substantially perpendicular to the first direction. Thereof is advantageous for the organization of the channels on the first separator plate.

Because the end parts of the corrugated channels have respective tangents at the junction points thereof which are all parallel to each other, the head loss of the first reactive gas passing through the junction point is substantially the same, whatever the corrugated channel used.

The fuel cell described hereinabove has multiple variants.

In the embodiment described hereinabove, the corrugated channels extend along a first direction D1 corresponding to the longitudinal direction L, i.e. to the direction of the large edges of the plate. In a variant, the first direction D1 is not merged with the longitudinal direction L, but forms an angle with the longitudinal direction L.

The oblique channels are not necessarily the channels belonging to the distribution zone 40 or to the distribution zone 42. Same may be formed on the central part 38 of the plate.

The first separator plate 21 is not necessarily in contact with the catalytic layer forming the anode. Same may be in contact with the catalytic layer forming the cathode.

The second separator plate is not necessarily of the same type as the first separator plate. Only one of the two separator plates can carry the corrugated channels and the oblique channels the junction points of which are regularly spaced along the first direction, as described hereinabove.

Corrugated channels do not necessarily have straight centerlines. The centerlines may have sections with different orientations.

The invention relates to a separator plate (21) which includes, in a first face: a plurality of corrugated channels (49) for the circulation of a first reactive gas, the corrugated channels (49) having respective end portions (50) all extending in the same first direction (D1) and forming corrugations having the same specific period (T1); a plurality of oblique channels (56), each extending in a second direction (D2) intersecting the first direction (D1), the end portion (50) of each corrugated channel (49) connecting to one of the oblique channels (56) at a junction point (58); the junction points (58) defining projection points (p) projecting onto a straight line (D) parallel to the first direction (D1), the projection being in a third direction (D3) perpendicular to the first direction (D1), the projection points (p) being regularly spaced apart from one another in the first direction (D1) and separated from one another by a constant spacing equal to a multiple of the specific period (T1).

1. A separator plate for an electrochemical cell of a fuel cell, the separator plate comprising, in a first side:
a plurality of corrugated channels for the circulation a first reactive gas, the corrugated channels having respective end parts all extending along a same first direction and forming corrugations having a same specific period;
a plurality of oblique channels, each extending along a second direction intersecting the first direction , the end part of each corrugated channel connecting to one of the oblique channels at a junction point;
the junction points defining projection points projecting onto a straight line parallel to the first direction, the projection being in a third direction perpendicular to the first direction, said projection points being regularly spaced apart from one another along the first direction and separated from one another by a constant gap equal to a multiple of the specific period.

2. The separator plate according to claim 1, wherein the projection points are separated from each other by a constant gap equal to said specific period.

3. The separator according to claim 1, wherein each corrugated channel comprises a main part extending along the first direction and forming large corrugations having a specific elongate period greater than the specific period of the corrugations of the end part, the end part of a corrugated channel extending between the main part and the junction point of said corrugated channel.

4. The separator plate according to claim 1, wherein the number of oblique channels is less than the number of corrugated channels, a plurality of corrugated channels coming out into the same oblique channel.

5. The separator plate according to claim 4, wherein the junction points (58) of the corrugated channels coming out into a same oblique channel define the same projection point on the straight line.

6. The separator plate according to claim 4, wherein the junction points of the corrugated channels coming out into the same oblique channel define at least two distinct projection points on the straight line.

7. The separator plate according to claim 1, wherein the junction points are placed on a straight line intersecting the first direction.

8. The separator plate according to claim 1, wherein the end parts of the corrugated channels have respective tangents at the junction points thereof, all parallel to each other.

9. A separator plate according to claim 1, wherein the oblique channels have oblique end parts connected to the junction points, the oblique end parts being rectilinear and parallel to each other.

10. A separator plate according to claim 9, wherein the oblique end parts extend along the third direction perpendicular to the first direction.

11. A fuel cell comprising a plurality of fuel cells, each fuel cell comprising:
an electrolyte membrane, having first and second large faces opposed to each other;
first and second catalytic layers arranged against the first and second large faces of the electrolyte membrane;
a separator plate according to claim 1, the first catalytic layer being arranged between the first face of the separator plate and the electrolyte membrane.
